(19) United States
(12) Patent Application Publication
(10) Pub. No.: US 2006/0140113 A1
(43) Pub. Date: Jun. 29, 2006

(54) Method for efficiently transmitting communications in a system supporting dedicated and shared communication channels

(76) Inventors: Erik E. Anderlind, Providence, CA (US); Achilles G. Kogiantis, Madison, NJ (US); Ashok N. Rudrapatna, Basking Ridge, NJ (US)

Correspondence Address: CARLSON, GASKEY & OLDS, P.C., 400 W MAPLE RD, SUITE 350, BIRMINGHAM, MI, 48009, US

(21) Appl. No.: 11/024,947

(22) Filed: Dec. 29, 2004

(51) Int. Cl. H04L 12/26

(52) U.S. Cl. 370/229

(57) ABSTRACT

A wireless communication system (20) includes a wireless network (30) that selects between a dedicated communication channel and a shared communication channel for transmitting a real-time communication such as a voice over internet protocol (VoIP) communication. In one example, a radio network controller (40) portion of the wireless network (30) evaluates channel conditions of the available channels for purposes of selecting the channel for the transmission that will maintain or enhance efficiency of the network. In a disclosed example, the selection is made at the initiation of a call. In another disclosed example, the selected channel condition or conditions are periodically evaluated to determine whether switching during a call is desirable. In another example, both channel types are used simultaneously at least during a handoff where a switch is made from one channel type to the other.

### FIELD OF THE INVENTION

This invention generally relates to telecommunications. More particularly, this invention relates to wireless communication systems.

### DESCRIPTION OF THE RELATED ART

Wireless communication systems have grown in capability and popularity. There are now various wireless service providers that provide voice, data and video communication capabilities to mobile units such as cell phones, personal digital assistants and notebook computers. With the increase in the number of service providers and the increased technological capabilities, wireless communications have become more and more widely used.

While known communication systems such as wireless systems are designed to meet various demands of subscribers, service providers continuously seek ways to improve the overall performance of the communication system. For example, efforts have been made to increase the throughput in wireless communications as they become more popular for subscribers to obtain data (i.e., email or information from the internet) using wireless mobile units.

For example, wireless third generation (3G) communication systems are currently introducing technologies in order to become spectrally efficient while supporting data services. These efforts have resulted in the development of the 3G x-EVDV standard, an evolution of the CDMA 2000 standard from the 3G PP2 body of standards. Similarly, the Universal Mobile Telecommunication System (UMTS) standard has introduced several advanced technologies as part of the high speed downlink packet access (HSDPA) specification. Dedicated or shared packet data channels (PDCH) under the CDMA standard are also known. One aspect of all of these example technologies is to ensure that any associated communications are carried in an efficient manner.

The nature of data transmissions allows for different handling techniques compared to voice transmissions. For example, data transmissions tend to be bursty in nature and can be sent at spaced intervals. Voice or other “real-time” communications, on the other hand, tend to be continuous and require different strategies for providing reliable and desirable service to subscribers.

Using known dedicated channel transmissions, a base station sets up a circuit switched connection in a known manner. Resources are reserved or dedicated for the entire call when such a circuit switched connection is established. The reserved or dedicated resources include Walsh codes and transmission power, for example.

With circuit switched connections, a packet or frame typically is delivered every twenty milliseconds or at another guaranteed delivery interval. As known, this technique is selected because of the continuous nature of real-time communications such as voice communications.

With data communications, on the other hand, there is no need to reserve resources for continuous communication. Data oriented connections and transmissions over shared channels only need to occur when data is available or requested. This does not occur on a continuous basis in most situations. Therefore, shared channels are not typically set up to efficiently handle continuous transmissions but are designed to maximize throughput of data on a more random or intermittent basis.

Another type of communication is known as voice over internet protocol (VoIP). It would be useful to be able to efficiently handle VoIP communications and other real-time communications that may be packetized in a wireless communication system. The present invention provides a technique for efficiently transmission VoIP communications.

### SUMMARY OF THE INVENTION

An exemplary disclosed method of communicating includes selecting between a shared channel and a dedicated channel for transmitting a real-time communication.

In one example, the real-time communication is a packetized voice communication such as a voice over internet protocol (VoIP) transmission.

In one example, at least one condition associated with each of the shared channel and the dedicated channel is evaluated. Based upon that evaluation, the channel having a condition that is better suited to facilitate the transmission is selected. The channel selection in one example maintains or enhances the efficiency of the system by conserving resources such as base station power or code/time/frequency occupation. In another example, the channel selection maintains or enhances system efficiency by increasing the capacity (i.e., the number of simultaneous users) serviced by a cell.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system that is capable of wirelessly transmitting real-time communications including packetized voice communications.

FIG. 2 is a flowchart diagram summarizing an example method of handling real-time transmissions.

### DETAILED DESCRIPTION

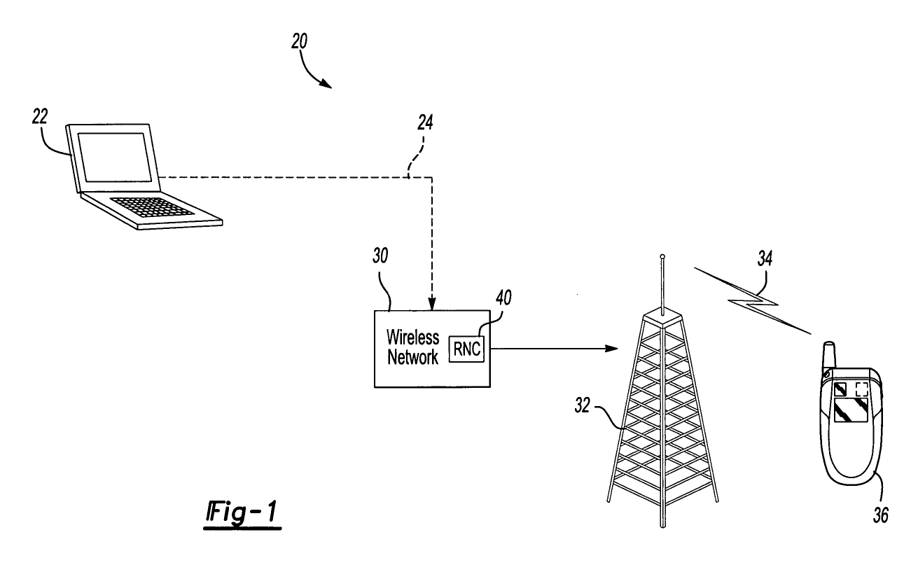

FIG. 1 schematically shows a wireless communication system 20 that is capable of supporting dedicated communication channels and shared communication channels. A source 22 of a real-time communication may be one of a variety of known devices. For example, the source 22 may be a mobile station such as a cell phone, notebook computer or a personal digital assistant. In such examples, a communication link 24 between the source 22 and a wireless network 30 will be at least partially wireless. In other examples, the source 22 may be a line-based device in which case the communication link 24 includes known transmission lines.

A voice communication is one example real-time communication. This description uses voice over internet protocol (VoIP) communications as an example type of communication for purposes of discussion. A VoIP communication can be referred to as a packetized real-time communication because the voice information can be handled in packets that can be transmitted as if they were data packets. This invention is not necessarily limited to VoIP communications and is useful for other packetized voice or other appropriately formatted real-time communications, for example.

The wireless network 30 comprises known components capable of receiving and handling at least VoIP communications. The wireless network 30 uses known techniques for processing the VoIP communication such that a base station 32 associated with the wireless network 30 provides a wireless transmission 34 of the VoIP communication to a mobile station 36. The example system is capable of using the disclosed example techniques on a forward link or a reverse link.

In one example, the wireless network 30 is capable of operating according to at least one standard such as 1x EV-DV. Other known communication systems such as 3G1x and EVDO, EVDV or UMTS R99 with HSDPA/EUDCH may be used, for example. The wireless network 30 is capable of supporting real-time (i.e., voice) communications using circuit switched connections where dedicated communication channels are used in a known manner to communicate transmissions to or from mobile stations. The wireless network 30 is also capable of supporting transmissions on shared communication channels such as packet data channels (PDCH) or an equivalent such that data or another packetized communication is accessible using mobile stations such as the example mobile station 36.

For VoIP communications, the wireless network 30 selects between transmitting the VoIP communication over a dedicated channel (i.e., using known circuit switched connection techniques) or over a shared channel (i.e., PDCH). The wireless network 30 selects an appropriate channel in a manner to maintain or enhance the efficiency of the network 30. For example, one measure of network efficiency is the number of subscribers serviced by a cell. In one example, the wireless network 30 makes the decision on which channel to select for a VoIP communication to maximize the number of subscribers and, therefore, to maximize efficiency.

Another example measure of efficiency is the conservation of resources such as base station power and code/time/frequency occupation. In one example, the wireless network 30 selects which channel to use for VoIP transmission to conserve such resources and, therefore, to maintain or enhance efficiency.

In the illustrated example, a radio network controller 40 of a radio access network portion of the wireless network 30 includes hardware, software, firmware or a combination of these for making the decision on which channel to select for a VoIP transmission. Given this description, those skilled in the art will be able to customize or design an appropriate radio network controller to meet the needs of their particular situation. Similarly, those skilled in the art who have the benefit of this description will realize which portion of a wireless network or base station will be best suited for making the determination regarding which channel type will provide the most efficient VoIP transmission to meet their particular needs.

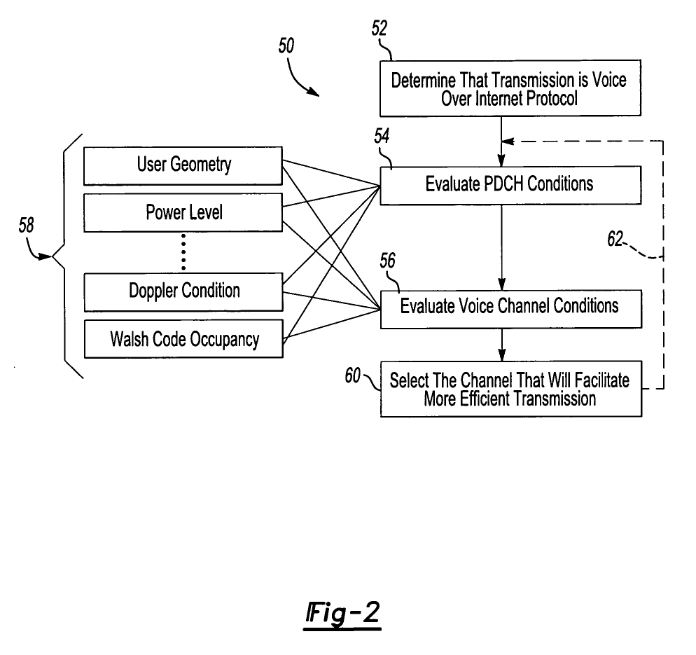

Referring to FIG. 2, a flowchart 50 summarizes an example approach for efficiently handling wireless VoIP transmissions. The example process begins at 52 where an appropriate portion of the wireless network 30 determines that the communication is VoIP. Given that, the radio network controller 40 (or another appropriate portion of the network 30) evaluates at least one condition of the available channels for the VoIP transmission. In the example of FIG. 2, shared channel (i.e., PDCH) conditions are evaluated at 54 and dedicated channel (i.e., a FCH or fundamental channel used for a CDMA voice call) conditions are evaluated at 56. A variety of channel conditions may be selected during this evaluation process. At least one condition that is indicative of system efficiency for each of the channels is used in the illustrated example.

As schematically shown in FIG. 2, a plurality of conditions 58 provide an indication of which channel will provide more efficiency. For example, the user geometry on the shared channel may indicate that the channel conditions are not desirable for a VoIP transmission. The term “user geometry” as used in this description should be understood to include the long term ratio of signal to interference-plus-noise. As known, this ratio is calculated as a long term average of the instantaneous channel conditions at the mobile station and is indicative of how strong the desired signal is compared to the noise level and any interference produced by other sources.

For example, the mobile station 36 may be in a location that would result in bad sound quality if using a packet data mode for the VoIP transmission. The same mobile station may have a much better user geometry over a dedicated channel because of, for example, the redundancy of circuit switched connections and the improved chances of having adequate sound quality. The redundancy associated with known techniques for using dedicated channels such as communications between multiple base stations and a mobile station, for example, may be a deciding factor for selecting a dedicated channel over a shared channel.

In one example, the user geometry on each of the channels is compared and the better geometry is selected for the VoIP transmission. In one example, whenever the user geometry is below a preselected threshold for either channel, the other channel is selected. An appropriate threshold can be selected, for example, that is predetermined as an indicator of a likelihood of an associated loss of one or more transmitted frames such that the sound quality at the mobile station 36 would be compromised.

Other example conditions such as the power level, current Doppler conditions, traffic volume on a channel and the Walsh code occupancy can be used in a similar manner.

It should be noted that because of the differences between dedicated channels and shared channels, a different condition may be used for each channel when evaluating which channel to select. In other words, the geometry of the user may be a more important factor when determining whether the shared channel is preferred while the traffic volume may be a more important factor when determining whether the dedicated channel should be selected. At least one condition associated with each channel that provides an indication of whether the transmission would be efficient using that channel is evaluated for each channel when making the selection between them.

Another example consideration for determining whether a shared channel is desirable for a transmission includes whether a scheduler associated with the shared channel can schedule the transmission in a manner that provides the minimum real-time performance that is desired. As known, shared channels typically have an associated scheduler that multiplexes in time. As the number of users increases, the delay between transmissions supporting a given user increases, which reduces real-time service quality. Maintaining a minimum real-time service quality may put a constraint on the number of users served on a shared channel, which lowers the system capacity. If the shared channel loading is such that real-time quality may be compromised or the number of served users is undesirably limited, then the dedicated channel may be the better option.

Whether the packetized real-time transmission can be arranged to match the frame size required to support real-time service on a dedicated channel is another example consideration. In some situations, a VoIP communication packet may contain an amount of voice data that fits well within a frame size that is the design frame size for a dedicated channel. In one example, a VoIP packet has 20 msec worth of voice data and a dedicated channel has a design frame size of 20 msec. In such an example, the VoIP communication can readily be handled using the dedicated channel.

One factor that may indicate a preference for a dedicated channel is that known dedicated channels utilize control channels that continuously send feedback (i.e., power control) and incrementally adapt the channel conditions. A shared channel may operate this way but not necessarily so. For example, the control adaptation on a shared channel may only be intermittent. Such a factor may impact the signal to interference-plus-noise ratio and influence the decision whether to select the shared channel or to prefer the dedicated channel. For example, better real-time quality and performance tends to be achieved by link quality or power control commands are sent continuously, rather than intermittently. There is less need for a link quality SINR margin to compensate for under-shoot or over-shoot of power when continuous commands are used. For a communication when a user is near an edge of a cell, there typically is a large system penalty for maintaining a high SINR margin and the system efficiency will be best maintained or enhanced when using a dedicated channel under such circumstances.

Given this description, those skilled in the art will realize how to take factors into consideration such as the examples provided in this description and how to weigh their relative importance when making a channel selection to meet the needs of their particular situation.

In FIG. 2, selecting the channel that facilitates more efficiency occurs at 60. In some examples, this selection will be made at the beginning of a call or communication session that includes VoIP transmissions.

In another example, as shown at 62, the network periodically reevaluates the channel conditions for switching between channels if that will result in better efficiency. Such an example accommodates the changing conditions or situation that may occur during a call, for example. When a mobile station 36 is moving through different areas, for example, the channel conditions associated with that mobile station may change and one example system maintains or enhances efficiency on a periodic basis by periodically evaluating whether the conditions have changed sufficiently to warrant switching between the dedicated channel and shared channel transmission option.

At least one example technique includes using the dedicated and shared channels, simultaneously. This example includes handoff procedures where a switch is made between the shared and dedicated channels. During a soft handoff procedure, for example, both channels will be used for transmitting such that both are selected at the same time. As known, circuit switched calls are carried through dedicated channels. Although dedicated channels are typically designed to carry circuit switched calls, a dedicated channel as used in an example implementation of this invention carries a true VoIP communication. In one example, the dedicated channel implementation is modified so that VoIP packets fit within the design voice frame size for the dedicated channel (i.e., 20 msec per frame). Having this capability allows for smoothly handing off when switching between channels. Such a technique also allows for dynamically switching between the channel types without an interruption in the service to the user.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
selecting between a shared channel and a dedicated channel for transmitting a real-time wireless communication.

2. The method of claim 1, comprising evaluating at least one condition associated with each of the shared channel and the dedicated channel and selecting the channel having the condition that is better suited to facilitate the transmission.

3. The method of claim 2, comprising selecting the channel having the condition that provides a more efficient transmission.

4. The method of claim 2, comprising periodically reevaluating the at least one condition and changing to the other channel if the condition has changed in a manner that is indicative of changing to the other channel for subsequent transmission.

5. The method of claim 2, wherein the condition comprises one of a power use level, a geometry of a mobile station, a Doppler condition or an occupancy level of Walsh Codes.

6. The method of claim 1, comprising selecting the channel when initiating a call that includes the real-time communication.

7. The method of claim 6, comprising periodically evaluating whether selecting the other channel will facilitate efficiently continuing the call.

8. The method of claim 1, wherein the transmission is from a base station to a mobile station and comprising selecting the channel based upon at least one forward link condition associated with each of the channels.

9. The method of claim 1, wherein the dedicated channel is associated with a circuit switched connection.

10. The method of claim 1, wherein the shared channel is a packet data channel.

11. The method of claim 1, wherein the real-time communication comprises a packetized voice communication.

12. The method of claim 11, wherein the real-time communication comprises a voice over internet protocol communication.

13. The method of claim 1, comprising selecting the dedicated channel and the shared channel for simultaneous transmission of the real-time communication.

14. The method of claim 13, comprising selecting the dedicated channel and the shared channel at least during a handoff that includes switching from one of the channels to the other channel.
